(19) United States
(12) Patent Application Publication
(10) Pub. No.: US 2014/0282617 A1
(43) Pub. Date: Sep. 18, 2014

(54) DENSITY-BASED EVENT HANDLING

(71) Applicant: Bert Tsu-Te Tan, Naperville, IL (US)

(72) Inventor: Bert Tsu-Te Tan, Naperville, IL (US)

(21) Appl. No.: 13/836,186

(22) Filed: Mar. 15, 2013

(51) Int. Cl. G06F 9/54

(52) U.S. Cl. CPC G06F 9/542
USPC 719/318

(57) ABSTRACT

The handling of an event is determined based on an event density associated with the event. The handling of an event is determined by determining an event density defined as a number of events (K) permitted within an inter-event time difference threshold (W), and determining handling of an event based on a comparison of an inter-event time difference and the inter-event time difference threshold, wherein the inter-event time difference is a difference between timestamps of the event and a K-th event prior to the event.

### TECHNICAL FIELD

The disclosure relates generally to event handling and, more specifically but not exclusively, to event handling in communication systems.

### BACKGROUND

As the use of smartphones continues to grow, the high volume of non-voice traffic generated and consumed by smartphones may overload the resources of wireless communication networks supporting the smartphones, which could impact voice call service supported by wireless communication networks.

### SUMMARY OF EMBODIMENTS

Various deficiencies in the prior art may be addressed by embodiments for density-based handling of events.

In one embodiment, an apparatus includes a processor and a memory communicatively connected to the processor. The processor is configured to determine an event density defined as a number of events (K) permitted within an inter-event time difference threshold (W), and determine handling of an event based on a comparison of an inter-event time difference and the inter-event time difference threshold, where the inter-event time difference includes a difference between a timestamp of the event and a timestamp of a K-th event prior to the event.

In one embodiment, a computer-readable storage medium stores instructions which, when executed by a computer, cause the computer to perform a method that includes determining an event density defined as a number of events (K) permitted within an inter-event time difference threshold (W), and determining handling of an event based on a comparison of an inter-event time difference and the inter-event time difference threshold, where the inter-event time difference includes a difference between a timestamp of the event and a timestamp of a K-th event prior to the event

In one embodiment, a method includes using a processor and a memory for determining an event density defined as a number of events (K) permitted within an inter-event time difference threshold (W), and determining handling of an event based on a comparison of an inter-event time difference and the inter-event time difference threshold, where the inter-event time difference includes a difference between a timestamp of the event and a timestamp of a K-th event prior to the event.

### BRIEF DESCRIPTION OF THE DRAWINGS

The teachings herein can be readily understood by considering the following detailed description in conjunction with the accompanying drawings, in which:

FIG. 1 depicts an exemplary system within which embodiments of the density-based event handling capability may be used;

FIG. 2 depicts an exemplary embodiment illustrating the determination of the handling of an event based on an event density associated with the event and an inter-event time difference associated with the event;

FIG. 3 depicts an exemplary embodiment of a method for determining handling of an event based on an event density associated with the event;

FIG. 4 depicts an exemplary embodiment of a method for determining handling of an event based on an event density associated with the event and an inter-event time difference associated with the event; and

FIG. 5 depicts a high-level block diagram of a computer suitable for use in performing functions described herein.

To facilitate understanding, identical reference numerals have been used, where possible, to designate identical elements that are common to the figures.

### DETAILED DESCRIPTION OF EMBODIMENTS

In general, a density-based event handling capability is provided herein. In at least some embodiments, the density-based event handling capability may support a determination as to handling of an event based on an event density associated with the event. In at least some embodiments, the density-based event handling capability may support a determination as to handling of an event based on a comparison of an inter-event time difference and an inter-event time difference threshold, where the inter-event time difference and the inter-event time difference threshold are determined based on the event density associated with the event. Various embodiments of the density-based event handling capability may be better understood by considering an exemplary system within which embodiments of the density-based event handling capability may be used, as depicted and described with respect to FIG. 1.

FIG. 1 depicts an exemplary system within which embodiments of the density-based event handling capability may be used.

As depicted in FIG. 1, exemplary system 100 includes a plurality of communication devices (CDs) 110₁-110_{N} (collectively, CDs 110), an event handling system (EHS) 120, and a communication network (CN) 130 that includes a plurality of network communication devices (NCDs) 132₁-132_{M} (collectively, NCDs 132). The density-based event handling capability supports handling of events for different event types, at least some of which are discussed in more detail below. It will be appreciated that, depending on the embodiment of the density-based event handling capability (e.g., the event type for which event-based handling of events is performed), fewer or more (as well as different) elements may be present within exemplary system 100 or the elements that are present within exemplary system 100 may be arranged in a different manner.

In at least some embodiments, the density-based event handling capability may be used for session admission control, where the events are requests for sessions in a communication network and handling of the events includes determining whether or not to admit the requested sessions to the communication network.

In at least some embodiments, in which session admission control is provided for controlling admission of sessions requested by end users, the CDs 110 may be end user devices requesting sessions to be transported via CN 130 (e.g., via NCDs 132 of CN 130). For example, the CDs 110 may include desktop computers, laptop computers, cellular phones, smart phones, set-top boxes, televisions, or the like. For example, the session requests may be requests for data sessions, voice call sessions, or the like. For example, EHS 120 may receive session requests from the CDs 110 and may use density-based event handling functions for determining whether or not to admit the requested sessions such that the sessions may be transported via CN 130. For example, the EHS 120 may be implemented as a data session admission controller (DSAC), a call admission controller (CAC), or the like. For example, the CN 130 may be a Public Switched Telephone Network (PSTN), a Radio Access Network (e.g., a Universal Mobile Telecommunication System (UMTS) Terrestrial Radio Access Network (UTRAN), an Evolved UTRAN (e-UTRAN), or the like), or the like. For example, NCDs 132 may be access nodes (e.g., nodeBs, eNodeBs, wireless access points (WAPs), or the like), switches, routers, servers, or the like.

In at least some embodiments, in which session admission control is provided for controlling admission of sessions requested by network devices, the CDs 110 may be network devices requesting sessions to be transported via CN 130. For example, the session requests may be requests for establishment of signaling sessions, requests for establishment of bearer sessions, or the like. For example, the CDs 110 may be servers, routers, or the like. For example, EHS 120 may receive session request from the CDs 110 and may use density-based event handling functions for determining whether or not to admit the requested sessions such that the sessions may be transported via CN 130. For example, the EHS 120 may be implemented as a signaling session admission controller (SSAC), a bearer session admission controller (BSAC), or the like. For example, CN 130 may be a core wireless network (e.g., UMTS Core Network, a Long Term Evolution (LTE) Evolved Packet Core (EPC) network, or the like), or the like. For example, the NCDs 132 may be control nodes (e.g., LTE Service Gateways (SGWs), LTE Packet Data Network (PDN) Gateways (PGWs), Mobility Management Entities (MMES), or the like), switches, routers, servers, hosts in a data center, or the like.

In at least some embodiments, the density-based event handling capability may be used for fault management, where the events are the occurrence or detection of faults and handling of the events includes determining whether or not to initiate fault recovery procedures for the faults. For example, faults may include faults that are detected by or received at a management system from a communication network or a portion of a communication network being managed by the management system (e.g., hardware failures, link failures, software malfunctions, switch performance degradation, or the like). For example, EHS 120 may receive or detect faults associated with CN 130 (e.g., reported by NCDs 132 of CN 130) and may use density-based event handling functions for determining whether or not to initiate fault recovery procedures for the faults. For example, EHS 120 may be implemented as a fault management module within or associated with a management system managing a communication network or a portion of a communication network (e.g., an Element Management System (EMS), a Network Management System (NMS), or the like). For example, the CN 130 may be a wired communication network, a wireless communication network, or the like. For example, the NCDs 132 may be switches, routers, servers, hosts in a data center, or the like. It will be appreciated that, although primarily depicted and described within the context of fault management for a communication network, the density-based event handling capability may be used for fault management within a device (e.g., EHS 120 is implemented as a module within the device that is configured to detect various types of faults at the device (e.g., hardware faults, firmware faults, software faults, or the like) and to determine whether or not to initiate fault recovery procedures for the faults at the device). In other words, the density-based event handling capability may be used for fault management at various levels of granularity.

In at least some embodiments, the density-based event handling capability may be used for attack prevention, where the events are the receipt of messages which may be used to attack a system and handling of the events includes determining whether or not to accept the received messages into the system. For example, messages may include Internet Protocol (IP) pings, Internet Control Message Protocol (ICMP) queries, or the like. For example, the CDs 110 may be user devices, network devices, or the like. For example, EHS 120 may receive messages from the CDs 110 and use density-based event handling functions for determining whether or not to accept the received messages into CN 130. For example, the EHS 120 may be implemented as a module within a server, as a system within a data center network (e.g., where CN 130 is the data center network), or the like. For example, the CN 130 may be a data communication network, a data center network, or the like. For example, the NCDs 132 may be switches, routers, servers, hosts in a data center, or the like.

It will be appreciated that, although primarily depicted and described herein with respect to use of embodiments of the density-based event handling capability for session admission control, fault management, and attack prevention, embodiments of the density-based event handling capability also may be used for handling various types of events in various types of systems, devices, environments, contexts, or the like. For example, embodiments of the density-based event handling capability may be used to determine handling of database access requests for retrieving data from a database, processing requests that request use of processing resources of a dedicated data center, processing requests that request use of virtual processing resources of a cloud-based data center, system access requests, network access requests, requests in a system supporting elastic capacity capabilities, or the like, as well as various other types of events for which processing may be performed to determine handling of the events. Accordingly, it will be appreciated that, although primarily depicted and described with respect to embodiments in which EHS 120 is a system within a communication network, EHS 120 may be implemented in any other suitable manner (e.g., as a device or system in communication with a communication network, as a module of a device or system within or in communication with a communication network, as a module of or associated with a device or a set of devices, or the like, as well as various combinations thereof). Furthermore, it will be appreciated that handling of events for at least some such event types may be necessary or desirable due to one or more constraints or limitations associated with the event types (e.g., available capacity of a system or network, quality-of-service requirements of a system or network, limitations in processing capabilities, limitations in availability of memory, fault tolerance requirements of a system or network, requirements to prevent against attacks, or the like, as well as various combinations thereof).

In at least some embodiments, the density-based event handling capability determines handling of an event based on an event density associated with the event and an inter-event time difference associated with the event.

In at least some embodiments, the event density associated with the event may be defined as a number of events (K) which are permitted within a time window W. That is, at any instant of time T, there may be at most K events within the time window W ending at time T. In other words, only K events are permitted to be distributed across the time window W, such that the value K/W is the limiting event density. It is noted that, while the event density K/W may appear to be defined as a permitted event rate, the event density K/W defines an event density in that the time window W is an inter-event time difference threshold that may be used to evaluate a time difference between a pair of events (e.g., the inter-event time difference threshold may be compared with an inter-event time difference that is computed based on the value of K), rather than a particular window of time on the clock that is independent of times associated with the events (e.g., when the events occurred, when the events were detected, or the like). Thus, the time window W of the event density K/W is primarily referred to herein as inter-event time difference threshold W (although it will be appreciated that the time window W also may be referred to as a time window threshold or, more simply, as a threshold).

In at least some embodiments, the inter-event time difference associated with the event may be defined as the difference between a timestamp of the event for which density-based event handling is performed (denoted as Tᵢ) and a timestamp of a K-th event prior to the event for which density-based event handling is performed (denoted as Tᵢ₋ₖ). It is noted that, depending on one or more factors (e.g., the event type, requirements of an entity that controls density-based event handling, requirements of a customer of an entity that controls density-based event handling, or the like), the K-th event prior to the event for which density-based event handling is performed may be (1) the K-th event prior to the event for which density-based event handling is performed irrespective of the handling of the event (e.g., the K-th event occurring prior to the event for which density-based event handling is performed, the K-th event detected prior to the event for which density-based event handling is performed, the K-th event received prior to the event for which density-based event handling is performed, or the like) or (2) the K-th event, that is handled in a particular manner, prior to the event for which density-based event handling is performed (e.g., the K-th voice call session that is accepted into the system prior to the voice call session request for which density-based event handling is performed, the K-th data session that is accepted into the system prior to the data session request for which density-based event handling is performed, or the like). It is noted that the event for which density-based event handling is performed also may be referred to herein as the current event in that it is the event that is currently being processed in order to determine event handling. It is also noted that, as discussed above, use of the inter-event time difference and the inter-event time difference threshold obviates the need for using a particular window of time on the clock that is independent of times of the events (e.g., when the events occurred, when the events were detected, or the like).

In at least some embodiments, determining the handling of an event based on an event density associated with the event and an inter-event time difference associated with the event includes determining an event density associated with the event (defined, as discussed above, as a number of events (K) permitted during an inter-event time difference threshold (W)) and determining handling of the event based on a comparison of an inter-event time difference and the inter-event time difference threshold, where the inter-event time difference includes the difference between a timestamp of the event and a timestamp of the K-th event prior to the event.

In at least some embodiments, determining the handling of an event based on an event density associated with the event and an inter-event time difference associated with the event includes determining the event density (K/W) associated with the event, determining a timestamp of the event, determining a timestamp of the K-th event prior to the event (where the value of K is determined from the event density), determining the inter-event time difference (denoted as Wᵢ) associated with the event as the difference between the timestamp of the event and the timestamp of the K-th event prior to the event, and determining handling of the event based on a comparison of the inter-event time difference Wᵢ and the inter-event time difference threshold W. The handling of the event based on the comparison of the inter-event time difference Wᵢ and the inter-event time difference threshold W may include initiating or performing a first type of event handling based on a determination that Wᵢ is less than (or less than or equal to) W and initiating or performing a second type of event handling based on a determination that Wᵢ is greater than (or greater than or equal to) W. It will be appreciated that handling of the event (e.g., the first type of event handling and the second type of event handling) may depend on the event type of the events, as illustrated in the following descriptions of embodiments related to session admission control, fault management, and attack prevention.

In at least one embodiment of session admission control, for example, the session request being processed is rejected if Wᵢ≦W (because there have been at least K sessions that have been accepted during the inter-event time difference threshold W, such that no additional sessions may be accepted at the time T at which handling of the session request is performed) and accepted if Wᵢ>W (because less than K sessions have been accepted during the inter-event time difference threshold W, such that a session may be established for the session request at the time T at which handling of the session request is performed).

In at least one embodiment of fault management, for example, where the event is a fault that has been detected, fault recovery procedures are initiated in response to the fault if Wᵢ≦W (because there have been at least K faults that have occurred during the inter-event time difference threshold W, such that fault recovery procedures need to be initiated to deal with the faults) and fault recovery procedures are not initiated in response to the fault if Wᵢ>W (because less than K faults have occurred during the inter-event time difference threshold W, such that it is not yet necessary to initiate fault recovery procedures).

In at least one embodiment of attack prevention, for example, the received message being processed is rejected if Wᵢ≦W (because there have been at least K messages that have been received during the inter-event time difference threshold W, which may be an indication that an attack is in progress and additional messages should be prevented from entering the system) and accepted if Wᵢ>W (because less than K messages have been received during the inter-event time difference threshold W, such that there is not yet a basis for a determination that an attack is in progress).

Various embodiments for determining the handling of an event based on an event density associated with the event and an inter-event time difference associated with the event may be better understood by way of reference to FIGS. 2-4.

FIG. 2 depicts an exemplary embodiment illustrating the determination of the handling of an event based on an event density associated with the event and an inter-event time difference associated with the event.

As depicted in FIG. 2, an event log 200 includes many events 210 which are arranged temporally based on timestamps (Tᵢ) associated with the events 210. The timestamps Tᵢ may represent times at which the events 210 occurred, times at which the events 210 were detected/received, times at which the events 210 were processed, times at which processing of the events 210 was completed, or the like. It will be appreciated that the type of time represented by the timestamps (Tᵢ) may depend on the event type of the events 210 being logged in the event log 200.

As depicted in FIG. 2, processing of a first event 212 having associated timestamp Tₙ resulted in a first type of event handling, because the inter-event time difference Wₙ associated with the event 212 is less than the inter-event time difference threshold W associated with the event density of the events 210. The inter-event time difference Wₙ associated with the event 212 is computed as the difference between the timestamp Tₙ of the event 212 and a timestamp Tₙ₋ₖ of the K-th event 214 in event log 200 that is prior to the event 212 having associated timestamp Tₙ. In at least one embodiment of fault management, for example, detection of the fault having associated timestamp Tₙ results in initiation of fault recovery procedures. The type of event handling performed for other event types will be understood by one skilled in the art and informed by the teachings herein.

As depicted in FIG. 2, processing of a second event 216 having associated timestamp Tₘ resulted in a second type of event handling, because the inter-event time difference Wₘ associated with the event 216 is greater than the inter-event time difference threshold W associated with the event density of the events 210. The inter-event time difference Wₘ associated with the event 216 is computed as the difference between the timestamp Tₘ of the event 216 and a timestamp Tₘ₋ₖ of the K-th event 218 in event log 200 that is prior to the event 216 having associated timestamp Tₘ. In at least one embodiment of fault management, for example, detection of the fault having associated timestamp Tₘ does not result in initiation of fault recovery procedures. As noted above, the type of event handling performed for other event types will be understood by one skilled in the art and informed by the teachings herein.

As described herein, inclusion of events 210 in the event log 200 may or may not be based on the handling of the events 210. In at least one embodiment of session admission control, for example, a session request for a session that is not accepted is not included in the event log 200, because the session density K/W is intended to control the number of sessions admitted to the system, rather than the number of session requests received (namely, a session that is not accepted and, thus, not supported by the system is not counted as part of the current session load of the system). In at least one embodiment of fault management, for example, each fault that is detected or received is included in the event log 200, because the fault density K/W is intended to control initiation of fault recovery procedures and each fault needs to be counted irrespective of whether or not that fault resulted in triggering of fault recovery procedures. In at least one embodiment of attack prevention, for example, each message that is received is included in the event log 200, because the message density K/W is intended to control initiation of attack prevention procedures and each message needs to be counted irrespective of whether or not that message resulted in triggering of attack prevention procedures.

FIG. 3 depicts an exemplary embodiment of a method for determining handling of an event based on an event density associated with the event. It will be appreciated that the steps of method 300, although primarily depicted and described as being performed serially, may be performed contemporaneously or in a different order than presented in FIG. 3.

At step 301, method 300 begins.

At step 310, an event density associated with an event is determined. The event density is defined as a number of events (K) permitted within an inter-event time difference threshold (W). The event may include receipt of a session request, receipt of an access request, detection of a fault, receipt of a message, or the like.

At step 320, handling of the event is determined based on the event density associated with the event. The determination of handling of the event based on the event density may include performing a comparison of the inter-event time difference for the event (which is determined based on the value of K of the event density) and the inter-event time difference threshold (which is the value of W of the event density). The inter-event time difference is determined as the difference between a timestamp of the event and a timestamp of the K-th event prior to the event. The handling of the event may include accepting a session, denying a session, permitting access to a system, denying access to a system, initiating a fault recovery procedure, preventing initiation of a fault recovery procedure, initiating an attack prevention procedure, preventing initiation of an attack prevention procedure, accepting a message, rejecting a message, or the like.

At step 399, method 300 ends.

FIG. 4 depicts an exemplary embodiment of a method for determining handling of an event based on an event density associated with the event and an inter-event time difference associated with the event. It will be appreciated that the steps of method 400, although primarily depicted and described as being performed serially, may be performed contemporaneously or in a different order than presented in FIG. 4.

At step 401, method 400 begins.

At step 410, an event is detected. The detection of the event may include monitoring for detection of the event, receiving an indication of the event, receiving a message, or the like. The detected event may have an event type associated therewith.

At step 420, an event density (K/W) associated with the detected event is determined. The event density is defined as a number of events (K) permitted within an inter-event time difference threshold (W). The determination of the event density (K/W) associated with the detected event may be based on the event type of the event.

At step 430, a timestamp (Tᵢ) of the detected event is determined. The timestamp Tᵢ of the detected event may include the time at which the event is detected, the time at which the detected event is processed for determining the handling of the detected event, or the like.

At step 440, a timestamp (Tᵢ₋ₖ) of the K-th event prior to the detected event is determined. The value of K may be determined from the event density (K/W) associated with the detected event. The K-th event prior to the detected event may be the K-th event that occurred prior to the detected event, the K-th event detected prior to the detected event, the K-th event handled in a particular manner prior to the detected event (e.g., where not all detected events are logged and considered when determining the K-th event prior to the detected event), or the like. The timestamp Tᵢ₋ₖ of the K-th event prior to the detected event may include the time at which the K-th event is detected, the time at which processing of the K-th event is initiated, the time at which processing of the K-th event is completed, or the like.

At step 450, an inter-event time difference (Wᵢ) is determined as the difference between the timestamp Tᵢ of the detected event and the timestamp Tᵢ₋ₖ of the K-th event prior to the detected event.

At step 460, handling of the detected event is determined based on a comparison of the inter-event time difference (Wᵢ) and the inter-event time difference threshold (W). The value of the inter-event time difference threshold W may be determined from the event density (K/W) associated with the detected event.

At step 470, handling of the detected event is initiated based on the determined handling of the detected event.

At step 499, method 400 ends.

As described herein, density-based event handling may be used within various types of networks, devices, environments, contexts, or the like. It will be appreciated that various benefits may be realized from the use of density-based event handling within the various types of networks, devices, environments, contexts, or the like. It also will be appreciated that various extensions of density-based event handling may be supported within the various types of networks, devices, environments, contexts, or the like.

In at least some embodiments, as described herein, density-based event handling may be used for call admission control. It will be appreciated that, since the assessment window moves with the incoming call, overload detection and shedding of traffic may be performed at the same time and in time when the call arrives. It will be appreciated that, at any instant of time, the incoming traffic is controlled within the desired running level or within the engineered capacity such that the system will never run into overload. It will be appreciated that density-based call admission control is proactive such that use of traditional traffic shedding in a reactive manner may be eliminated. It will be appreciated that density-based call admission control may be applied such that quality of service at the call admission controller may be maintained at a desired (e.g., optimal) level.

In at least some embodiments, as described herein, density-based event handling may be used to provide admission control for various types of communication services (e.g., data sessions, voice calls, or the like). It will be appreciated that admission control may be managed (e.g., enabled/disabled, dynamically adjusted, or the like) on a per communication service type basis. It will be appreciated that, although primarily depicted and described with respect to use of a single density for a given communication service type, multiple densities (e.g., discrete values, ranges of values, or the like) may be used for a given communication service type (and that multiple density control parameters may be employed to dynamically control use of the multiple densities for the given communication service type). In at least some embodiments, for example, each communication service type may have the following density control parameters associated therewith: (1) a starting density value, (2) an increment/decrement value (e.g., an amount by which the density may be incremented or decremented when a determination is made that the density is to be changed), and (3) a maximum density value. It will be appreciated that the values of the density control parameters may be different across the communication service types. In at least some embodiments, density control parameters may be set or adjusted for known traffic pattern changes based on temporal considerations (e.g., busy hours, day hours, night hours, weekdays, weekends, holidays, sporting events, or the like). In at least some embodiments, density control parameters may be set or adjusted for emergency traffic pattern changes (e.g., natural disasters, terrorist attacks, or the like). In at least some embodiments, density control parameters may be set or adjusted based on real-time traffic pattern changes (e.g., call admission starts at an initial density and may be dynamically adjusted (e.g., incremented or decremented) based on a feedback loop and control logic while being capped at a desired maximum density value). In at least some embodiments, determination of event handling of events for different communication service types may be performed together (e.g., where an event density for a first communication service type indicates that admission of a session or call is not permitted, the session or call may still be admitted if a determination is made that an event density for a second communication service type indicates that admission of the session or call is permitted (e.g., the first communication service may borrow resources originally prescribed for use by the second communication service). It will be appreciated that management of multiple communication services using embodiments of density-based event handling may be performed in various other ways. In at least some embodiments, use of density-based event handling obviates the need for detection of an overload condition before overload control procedures are initiated.

In at least some embodiments, the event density for an event type may be defined at any suitable level of granularity (e.g., for all devices of a system or network, for a subset of devices of a system or network, for all customers of a provider, on a per-customer or per-customer-group basis for customers of a provider, or the like, as well as various combinations thereof).

In at least some embodiments, the event density for an event type may be set or adjusted by a provider, a customer, or the like. In at least some embodiments, the event density for an event type may be set or adjusted dynamically. In at least some embodiments, the event density for an event type may be set or adjusted based on one or more event density control parameters (e.g., an initial event density value, an increment/decrement amount value, a maximum event density value, or the like, as well as various combinations thereof). In at least some embodiments, the event density for an event type may be set or adjusted based on temporal considerations.

It will be appreciated that, although primarily depicted and described with respect to use of specific conditions to determine handling of an event (e.g., accept a requested session if the inter-event time difference Wᵢ is greater than the inter-event time difference threshold W, initiate fault recovery procedures if the inter-event time difference Wᵢ is less than or equal to the inter-event time difference threshold W, or the like), the conditions used to determine handling of an event may be defined in various other ways (e.g., accept a requested session if the inter-event time difference Wᵢ is greater than or equal to the inter-event time difference threshold W, initiate fault recovery procedures if the inter-event time difference Wᵢ is less than the inter-event time difference threshold W or the like). Accordingly, references herein to determining handling of an event based on a comparison of the inter-event time difference Wᵢ and the inter-event time difference threshold W may be read more generally as determining handling of an event based on a result of a comparison of the inter-event time difference Wᵢ and the inter-event time difference threshold W (e.g., a first result indicates a first type of event handling for the event and a second result indicates a second type of event handling for the event), determining handling of an event based on a determination as to whether or not a condition associated with a comparison of the inter-event time difference Wᵢ and the inter-event time difference threshold W is satisfied (e.g., a determination that the condition is satisfied results in a first type of event handling for the event and a determination that the condition is not satisfied results in a second type of event handling for the event), or the like.

It will be appreciated that, although primarily depicted and described herein with respect to embodiments in which the density-based event handling capability is used to determine handling of events where the event density is based on a number of events, in at least some embodiments the density-based event handling capability is used to determine handling of events where the event density is based on one or more other parameters related to the events (e.g., an amount of resources to be consumed based on the event or the like).

It will be appreciated that, although primarily depicted and described herein with respect to embodiments in which the density-based event handling capability is used to determine handling events using a single event density and two (2) event handling options (e.g., a binary scheme), in at least some embodiments the density-based event handling capability may be used to determine handling of events using multiple event densities and three or more event handling options (e.g., for Wᵢ<W1 handle the event using a first event handling option, W1<Wᵢ<W2 handle the event using a second event handling option, or for Wᵢ>W2 handle the event using a third event handling option).

It will be appreciated that, although primarily depicted and described herein with respect to embodiments in which the density-based event handling capability supports specific types of event handling (e.g., accepting or denying a request, initiating or not initiating fault recovery procedures, or the like), in at least some embodiments one or more other types of event handling may be used (which may depend on the associated event type(s) for which event handling is being performed). For example, other types of event handling may include delaying processing of the event (e.g., delayed session or call admission, delayed system admission, or the like), redirecting the event (e.g., to a different system, network, processor, or the like), preempting in order to accommodate the event (e.g., preempting an existing call to support the current call (e.g., an emergency call), preempting an existing session to support the current session (e.g., a session requiring a higher QoS), preempting an existing assignment of cloud resources to support the current cloud resource request, or the like), or the like, as well as various combinations thereof.

It will be appreciated that, although primarily depicted and described herein with respect to embodiments in which the density-based event handling capability is used to determine handling events of a single event type, the density-based event handling capability may be used to determine handling of events of multiple event types.

FIG. 5 depicts a high-level block diagram of a computer suitable for use in performing functions described herein.

The computer 500 includes a processor 502 (e.g., a central processing unit (CPU) or other suitable processor(s)) and a memory 504 (e.g., random access memory (RAM), read only memory (ROM), and the like).

The computer 500 also may include a cooperating module/process 505. The cooperating process 505 can be loaded into memory 504 and executed by the processor 502 to implement functions as discussed herein and, thus, cooperating process 505 (including associated data structures) can be stored on a computer readable storage medium, e.g., RAM memory, magnetic or optical drive or diskette, and the like.

The computer 500 also may include one or more input/output devices 506 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 500 depicted in FIG. 5 provides a general architecture and functionality suitable for implementing functional elements described herein or portions of functional elements described herein. For example, the computer 500 may provide a general architecture and functionality suitable for implementing one or more of a CD 110, a portion of a CD 110, an EHS 120, a portion of an EHS 120, an NCD 132, a portion of an NCD 132, or the like.

It will be appreciated that the functions depicted and described herein may be implemented in hardware or a combination of software and hardware, e.g., using a general purpose computer, via execution of software on a general purpose computer so as to provide a special purpose computer, using one or more application specific integrated circuits (ASICs) or any other hardware equivalents, or the like, as well as various combinations thereof.

It will be appreciated that at least some of the method steps discussed herein may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods or techniques described herein are invoked or otherwise provided. Instructions for invoking the inventive methods may be stored in fixed or removable media, transmitted via a data stream in a broadcast or other signal bearing medium, or stored within a memory within a computing device operating according to the instructions.

It will be appreciated that the term “or” as used herein refers to a non-exclusive “or” unless otherwise indicated (e.g., “or else” or “or in the alternative”).

It will be appreciated that, while the foregoing is directed to various embodiments of features present herein, other and further embodiments may be devised without departing from the basic scope thereof.

What is claimed is:

1. An apparatus configured to determine handling of events of an event type, comprising:
a processor and a memory communicatively connected to the processor, the processor configured to:
determine an event density defined as a number of events (K) permitted within an inter-event time difference threshold (W); and
determine handling of an event based on a comparison of an inter-event time difference and the inter-event time difference threshold, wherein the inter-event time difference comprises a difference between a timestamp of the event and a timestamp of a K-th event prior to the event.

2. The apparatus of claim 1, wherein the processor is configured to:
determine an event type of the event; and
determine the event density based on the event type of the event.

3. The apparatus of claim 1, wherein the processor is configured to:
determine the timestamp of the event;
determine the timestamp of the K-th event prior to the event; and
determine the inter-event time difference as the difference between the timestamp of the event and the timestamp of the K-th event prior to the event.

4. The apparatus of claim 3, wherein the processor is configured to determine the timestamp of the K-th event prior to the event by identifying the K-th event in an event log.

5. The apparatus of claim 1, wherein the processor is configured to:
initiate a first type of event handling for the event based on a first result of the comparison of the inter-event time difference and the inter-event time difference threshold.

6. The apparatus of claim 1, wherein the processor is configured to:
initiate a first type of event handling for the event when a result of the comparison of the inter-event time difference and the inter-event time difference threshold is a first result; and
initiate a second type of event handling for the event when the result of the comparison of the inter-event time difference and the inter-event time difference threshold is a second result.

7. The apparatus of claim 1, wherein the event comprises receipt of a first request for a session and the K-th event comprises receipt of a K-th request for a session in which the K-th requested session was accepted, wherein the K-th request for a session is prior in time to the first request.

8. The apparatus of claim 7, wherein the processor is configured to:
accept the first request for the session based on a determination that the inter-event time difference is equal to the inter-event time difference threshold or is equal to or greater than the inter-event time difference threshold.

9. The apparatus of claim 7, wherein the processor is configured to:
deny the first request for the session based on a determination that the inter-event time difference is less than the inter-event time difference threshold or is less than or equal to the inter-event time difference threshold.

10. The apparatus of claim 1, wherein the event comprises detection of a first fault and the K-th event comprises detection of a K-th fault prior to the first fault.

11. The apparatus of claim 10, wherein the processor is configured to:
initiate a fault recovery procedure responsive to the first fault based on a determination that the inter-event time difference is less than the inter-event time difference threshold or is less than or equal to the inter-event time difference threshold.

12. The apparatus of claim 1, wherein the event comprises receipt of a first message and the K-th event comprises receipt of a K-th message prior to the first message.

13. The apparatus of claim 12, wherein the processor is configured to:
admit the first message based on a determination that the inter-event time difference is equal to the inter-event time difference threshold or is equal to or greater than the inter-event time difference threshold.

14. The apparatus of claim 12, wherein the processor is configured to:
reject the first message based on a determination that the inter-event time difference is less than the threshold or is less than or equal to the threshold.

15. The apparatus of claim 1, wherein the processor is configured to:
determine whether to add the event to an event log based on the comparison of the inter-event time difference and the inter-event time difference threshold.

16. The apparatus of claim 1, wherein the event comprises one of receipt of a session request, receipt of a session request in which the session request is accepted, receipt of an access request, detection of a fault, or receipt of a message.

17. The apparatus of claim 1, wherein handling of the event comprises one of accepting a session, denying a session, permitting access to a system, denying access to a system, initiating a fault recovery procedure, preventing initiation of a fault recovery procedure, initiating an attack prevention procedure, preventing initiation of an attack prevention procedure, accepting a message, or rejecting a message.

18. The apparatus of claim 1, wherein the processor is configured to modify the event density.

19. A computer-readable storage medium storing instructions which, when executed by a computer, cause the computer to perform a method, the method comprising:
determining an event density defined as a number of events (K) permitted within an inter-event time difference threshold (W); and
determining handling of an event based on a comparison of an inter-event time difference and the inter-event time difference threshold, wherein the inter-event time difference comprises a difference between a timestamp of the event and a timestamp of a K-th event prior to the event.

20. A method, comprising:
using a processor and a memory for:
determining an event density defined as a number of events (K) permitted within an inter-event time difference threshold (W); and
determining handling of an event based on a comparison of an inter-event time difference and the inter-event time difference threshold, wherein the inter-event time difference comprises a difference between a timestamp of the event and a timestamp of a K-th event prior to the event.
